(19) United States
(12) Patent Application Publication
(10) Pub. No.: US 2025/0384323 A1
(43) Pub. Date: Dec. 18, 2025

(54) SYSTEM AND METHOD OF IMPROVING FIDELITY IN EXECUTION OF QUANTUM PROGRAMS

(71) Applicant: THE UNIVERSITY OF CHICAGO, Chicago, IL (US)

(72) Inventors: Frederic T. CHONG, Chicago, IL (US); Gokul Subramanian RAVI, Chicago, IL (US)

(21) Appl. No.: 18/878,210

(22) PCT Filed: Jun. 27, 2023
(86) PCT No.: PCT/US2023/069154

§ 371 Date: Dec. 23, 2024

Related U.S. Application Data
(60) Provisional application No. 63/355,797, filed on Jun. 27, 2022.

(51) Int. Cl. G06N 10/60

(52) U.S. Cl. CPC G06N 10/60

(57) ABSTRACT

A quantum computing system including a plurality of quantum computing resources, and at least one classical processor configured to: create and execute a canary circuit corresponding to the original quantum circuit on the at least one classical processor; identify a classical canary output; identify a canary ordering of quantum computing resources that increases a likelihood of generating the classical canary output on the plurality of quantum computing resources; execute the original quantum circuit on the plurality of quantum computing resources; identify a set of actual outputs generated by execution of the original quantum circuit on the plurality of quantum computing resources; associate an ordering of the plurality of quantum computing resources corresponding to each actual output of the set of actual outputs; and determine a correct output of the original quantum circuit based on comparing the ordering of the plurality of quantum computing resources with the canary ordering.

### CROSS REFERENCE TO RELATED APPLICATION

This application claims priority to and the benefit of U.S. Provisional Patent Application Ser. No. 63/355,797, entitled SYSTEM AND METHOD OF IMPROVING FIDELITY IN EXECUTION OF QUANTUM PROGRAMS, filed Jun. 27, 2022, the contents of which are incorporated herein in their entirety.

### STATEMENT REGARDING FEDERALLY SPONSORED RESEARCH & DEVELOPMENT

This invention was made with government support under 1730449 and 2030859 awarded by the National Science Foundation. The government has certain rights in the invention.

### TECHNICAL FIELD

This disclosure relates generally to quantum computing and, in particular, to systems and methods for improving fidelity in execution of quantum programs.

### BACKGROUND

Recent developments in quantum computing have pushed quantum computers closer to solving classically intractable problems. Existing quantum programming languages and compilers use a quantum assembly language composed of 1- and 2-quantum bit (“qubit”) gates to prepare and execute primitive operations on quantum computers. Recent advancements in hardware and software include devices such as IBM's 50-qubit quantum machine and Google's 72-qubit machine, as well as classical-quantum hybrid algorithms tailored for such Noisy Intermediate-Scale Quantum (“NISQ”) machines, such as Quantum Approximate Optimization Algorithm (“QAOA”) and Variational Quantum Eigensolver (“VQE”).

However, today's NISQ machines include imperfect qubits causing high error rates caused by state preparation and measurement (SPAM) errors, gate errors, qubit decoherence, measurement errors or readout errors, and/or crosstalk, and so on. These errors occur due to multiple noise sources, for example, imperfect classical control of quantum devices, thermal fluctuations, destructive qubit coupling, connectivity related issues, imperfect insulation of the qubits, quasi-particles, and/or other external stimuli. Currently known fabrication techniques lack the precision to make homogeneous batches of quantum devices, and, therefore, noise properties are distinct for each quantum devices. In addition, due to dynamic nature of quantum devices, noise sources are not consistent or static, but instead the noise sources go through spatial and/or temporal variation. Accordingly, a quantum application's execution is impacted by noise sources having dynamic characteristics, which further impacts each quantum application's fidelity to be impacted in a unique way.

Various error mitigation techniques have been explored and being used to reduce effect of noise on circuit execution on the quantum machine. These error mitigation techniques include, for example, noise-aware compilation, scheduling to reduce crosstalk, 1Q gate scheduling in idle windows, dynamic decoupling, zero-noise extrapolation, readout error mitigation, exploiting quantum reversibility, and so on. However, even with the currently known error mitigation techniques, execution fidelity is still extremely small for most quantum circuits of more than 10 qubits. In the NISQ era, quantum hardware with hundreds or thousands of qubits is anticipated. And, using the currently available classical computing system assisted by supercomputers, quantum systems of about 50 qubits can be simulated.

Accordingly, in addition to innovate across hardware and software stack to improve execution fidelity, techniques that boost quantum application's execution fidelity on quantum systems of a large number of qubits are desired such that correct quantum circuit output can be identified.

### BRIEF DESCRIPTION

In one aspect, a quantum computing system providing quantum processing as a service is disclosed. The quantum computing system includes a plurality of quantum computing resources, a classical memory storing an original quantum circuit of a quantum application, and at least one classical processor. Each quantum computing resource of the plurality of quantum computing resources includes a plurality of qubits. The at least one classical processor executes instructions to create a canary circuit corresponding to the original quantum circuit and execute the canary circuit on the at least one classical processor. The at least one classical processor identifies a classical canary output based on execution of the canary circuit on the at least one classical processor. The at least classical processor executes the canary circuit on the plurality of quantum computing resources to generate the classical canary output and identifies a respective canary ordering of each quantum computing resource of the plurality of quantum computing resources that increases a likelihood of generating the classical canary output when the canary circuit is executed on the plurality of quantum computing resources. The at least classical processor cause execution of the original quantum circuit on each quantum computing resource of the plurality of quantum computing resources and identifies a set of actual outputs generated by execution of the original quantum circuit on the plurality of quantum computing resources. The at least classical processor associates a respective ordering of each quantum computing resource of the plurality of quantum computing resources corresponding to each actual output of the set of actual outputs and compares the respective ordering of each quantum computing resource of the plurality of quantum computing resources with the respective canary ordering of each quantum computing resource of the plurality of quantum computing resources. Based on the comparison, the at least one classical processor determines a correct output of the original quantum circuit, the correct output corresponds with the actual output produced by the respective ordering of each quantum computing resource of the plurality of quantum computing resources that most resembles with the respective canary ordering of each quantum computing resource of the plurality of quantum computing resources.

In another aspect, a method for identifying a correct output of a quantum application circuit executed on a plurality of quantum computing resources is disclosed. The method is implemented using at least one classical processor in communication with a classical memory. The method includes generating a canary circuit corresponding to the quantum application circuit, executing the canary circuit on the at least one classical processor, and identifying a classical canary output based on execution of the canary circuit on the at least one classical processor. The method includes causing execution of the canary circuit on the plurality of quantum computing resources to generate the classical canary output and identifying a respective canary ordering of each quantum computing resource of the plurality of quantum computing resources that increases a likelihood of generating the classical canary output when the canary circuit is executed on the plurality of quantum computing resources. The method includes executing (or causing execution of) the quantum application circuit on the plurality of quantum computing resources and identifying a set of actual outputs generated by execution of the quantum application circuit on the plurality of quantum computing resources. The method includes associating a respective ordering of each quantum computing resource of the plurality of quantum computing resources corresponding to each actual output of the set of actual outputs. The method includes comparing the identified respective ordering of each quantum computing resource of the plurality of quantum computing resources with the respective canary ordering of each quantum computing resource of the plurality of quantum computing resources, and based on the comparison, determining the correct output of the quantum application circuit, the correct output corresponds with the actual output produced by the respective ordering of each quantum computing resource of the plurality of quantum computing resources that most resembles with the respective canary ordering of each quantum computing resource of the plurality of quantum computing resources.

In yet another aspect, a method for executing a quantum application circuit on a plurality of quantum computing resources is disclosed. The method includes generating a canary circuit corresponding to the quantum application circuit, executing the canary circuit on the at least one classical processor, and identifying a classical canary output based on execution of the canary circuit on the at least one classical processor. The method includes causing execution of the canary circuit on the plurality of quantum computing resources to generate the classical canary output and identifying a respective canary ordering of each quantum computing resource of the plurality of quantum computing resources that increases a likelihood of generating the classical canary output when the canary circuit is executed on the plurality of quantum computing resources. The method includes executing the quantum application circuit on each quantum computing resource of the plurality of quantum computing resources, each quantum computing resource of the plurality of quantum computing resources is ordered according to the identified respective canary ordering of each quantum computing resource of the plurality of quantum computing resources.

In yet another aspect, a method for executing a quantum application circuit on a plurality of quantum computing resources. The method is implemented using at least one classical processor in communication with a classical memory. The method includes generating a canary circuit corresponding to the quantum application circuit, executing the canary circuit on the at least one classical processor, and identifying a classical canary output based on execution of the canary circuit on the at least one classical processor. The method includes causing execution of the canary circuit on each of the plurality of quantum computing resources to generate the classical canary output and identifying a respective likelihood of generating the classical canary output on each quantum computing resource of the plurality of quantum computing resources when the canary circuit is executed on each quantum computing resource of the plurality of quantum computing resources. The method includes executing the quantum application circuit on a quantum computing resource of the plurality of quantum computing resources based on an availability and the identified likelihood corresponding to each quantum computing resource of the plurality of quantum computing resources.

### BRIEF DESCRIPTION OF THE DRAWINGS

FIGS. 1-5 show exemplary embodiments of the methods and systems described herein, in accordance with some embodiments.

FIG. 1 is a diagram of exemplary quantum computing system for executing variational quantum programs on a quantum computing device.

FIG. 2A and FIG. 2B illustrate views corresponding to generating a Clifford canary circuit that closely resembles to a structure of a quantum application circuit.

FIG. 3 is an example 2-qubit quantum application circuit.

FIG. 4A and FIG. 4B illustrate an example flow-chart of method operations to identify a correct output from execution of a quantum application circuit on quantum computing devices of an ensemble.

FIG. 5 illustrates an example flow-chart of method operations to identify an appropriate ordering of quantum computing devices of an ensemble that increases execution fidelity of the quantum application circuit.

### DETAILED DESCRIPTION OF THE DISCLOSURE

The following detailed description illustrates embodiments of the disclosure by way of example and not by way of limitation. It is contemplated that the disclosure has general application to quantum computing.

Embodiments of the present disclosure are directed to boost execution fidelity of quantum applications to identify correct output of quantum applications or a large number of qubits. In one example, the quantum applications may be of 50 qubits, 100 qubits, or any other number of qubits. Imperfections in a manufacturing process or fabrication process, as well as static and/or dynamic variation in noise sources may make each quantum device unique. Each quantum device may therefore impact a quantum application's execution and fidelity in its unique way.

In other words, each quantum device may not be the most suitable quantum device for a particular quantum application. A better quantum device for a particular quantum application is one that has higher fidelity in comparison with other quantum devices executing the same particular quantum application. A quantum device that is a better quantum device for a particular quantum application has comparatively higher probability of generating a correct quantum application outcome in its output distribution.

Generally, a quantum application is executed on an ensemble of multiple quantum devices, or a quantum application of multiple qubits may have different qubits mapped to different quantum devices of an ensemble. A particular quantum device's execution fidelity may impact the final output from the ensemble of quantum devices (e.g., a chain of quantum devices) executing the particular quantum application. Accordingly, if an order of quantum devices executing the particular quantum application can be identified that would have higher probability to generate a correct outcome, execution fidelity of the quantum application may be increased.

In the present disclosure, a unique approach to identify correct ordering of quantum devices that increases execution fidelity is described. The approach to increase execution fidelity is based on diversity and/or uniqueness of quantum devices due to static and/or dynamic noise variations, as described herein. In some examples, Clifford canary circuits may be used to identify the correct ordering of quantum devices. In Clifford canary circuit, all non-Clifford gates are replaced with the nearest Clifford gates. The Clifford canary circuits are classically simulable and also resemble a target quantum application circuit's structure. Since the Clifford canary circuit resembles the target quantum application circuit's structure, the Clifford canary circuit also have similar impact from noise sources like the target quantum application circuit's structure. Accordingly, using the Clifford canary circuit, a possible correct outcome of the target quantum application may be known and leveraged to identify a correct ordering of quantum devices in the ensemble, as described herein.

The Clifford canary circuit is executed on an ensemble of the quantum devices. A correct output string (an output distribution) for a quantum application circuit corresponding to the Clifford canary circuit may be obtained by executing (or running) the Clifford canary circuit ideally on a classical machine (or a classical computing device) since the Clifford canary circuit are classically simulable. Next, the Clifford canary circuit is executed on the ensemble to obtain a canary ordering (or an ordering of machines) producing the correct output string. As described herein, the ordering of machines producing the correct output string for the Clifford canary circuit is going to be very close to an ordering of quantum devices of the ensemble producing the correct output because the Clifford canary circuit resembles the target quantum application circuit's structure.

In other words, because the Clifford canary circuit maintains the exact device-mapped circuit structure of the original quantum target application by having the same circuit critical depth or paths, the same number of 2-qubit Controlled-NOT (“CNOT” or “CX”) gates, and/or the same number of measurement bits, an ordering of machines generating the particular output (or the output string) of the Clifford canary circuit may be the most closest ordering of the quantum devices in the ensemble that has much higher probability to produce the correct output for the quantum application circuit to be executed on the ensemble. Thus, a quantum application's execution fidelity may be increased using Quantum Canary Ordered Diverse ensembles, which is referred herein as Quancorde.

The quantum application circuit's execution fidelity is increased as various quantum computing devices of the ensemble are ordered in a sequence which is more likely to produce the correct output distribution. Additionally, or alternatively, based on the identified ordering of various quantum computing devices of the ensemble, one or more quantum computing devices of the ensemble may be selected to execute the quantum application circuit based on an availability of each quantum computing device of the ensemble. By way of a non-limiting example, the availability of each quantum computing device of the ensemble may depend on a number of jobs queued for execution by each quantum computing device.

In some examples, execution fidelity of quantum applications may be increased on an average by 3 times to 6.9 times. In some examples, execution fidelity of quantum applications may be increased up to 31.3 times. Further, when there are 1000s of possible output strings for a target quantum application, then the most likely 1-10s of output strings may be identified using Quancorde. Accordingly, various embodiments, as described herein, using Quancorde, fundamental limitations of a noisy quantum device may be overcome and application fidelity beyond the execution capability of a single quantum device may be improved.

An ensemble of quantum computing devices and associated methods are described herein for addressing these problems. The ensemble of quantum computing devices includes a plurality of quantum computing devices, and each quantum computing device of the plurality of quantum computing devices executes a particular operation of quantum application in parallel with other operations. Measurements of qubits in an individual computer is not performed. But instead, only expectation values (over the complete ensemble of computers), e.g., an expected output string is measured.

The ensemble of quantum computing devices described herein includes a classical computing device, and a plurality of quantum computing devices. The classical computing device may be configured to execute a canary circuit (e.g., a Clifford canary circuit, and/or a canary circuit including small number of non-Clifford gates). The classical computing device may also include a compilation engine that is configured to prepare and optimize a quantum program for execution on a quantum processor of a quantum computing device. In some examples, the quantum processor may include tens, hundreds of qubits for use in execution, with thousands of qubits expected in the future. The compilation engine may be configured to prepare and execute variational algorithms on the quantum processor using partial compilation strategies prior to runtime that can improve compilation latency during runtime (e.g., increasing runtime compilation efficiency, reducing runtime compilation time).

The term “classical,” as used herein, refers to conventional transistor-based computing technology. This term, where necessary, is used to distinguish conventional computing devices or associated hardware, software, algorithms, and such, from “quantum” computing. Quantum computing devices or associated hardware, software, algorithms, and such, are typically distinguished from classical computing devices based on their reliance on quantum phenomena of quantum mechanics to perform processing operations. Example classical computing devices include conventional personal computers, servers, tablets, smartphones, x86-based processors, random access memory (“RAM”) modules, and so forth. Example quantum computing devices include “IBM Q” devices from International Business Machines (IBM), “Bristlecone” quantum computing device from Google, “Tangle Lake” quantum computing device from Intel, and “2000Q” from D-Wave. The term “classical bit” or “cbit” may be used herein to refer to a bit within classical computing. The term “qubit” may be used herein to refer to a quantum bit in quantum computing.

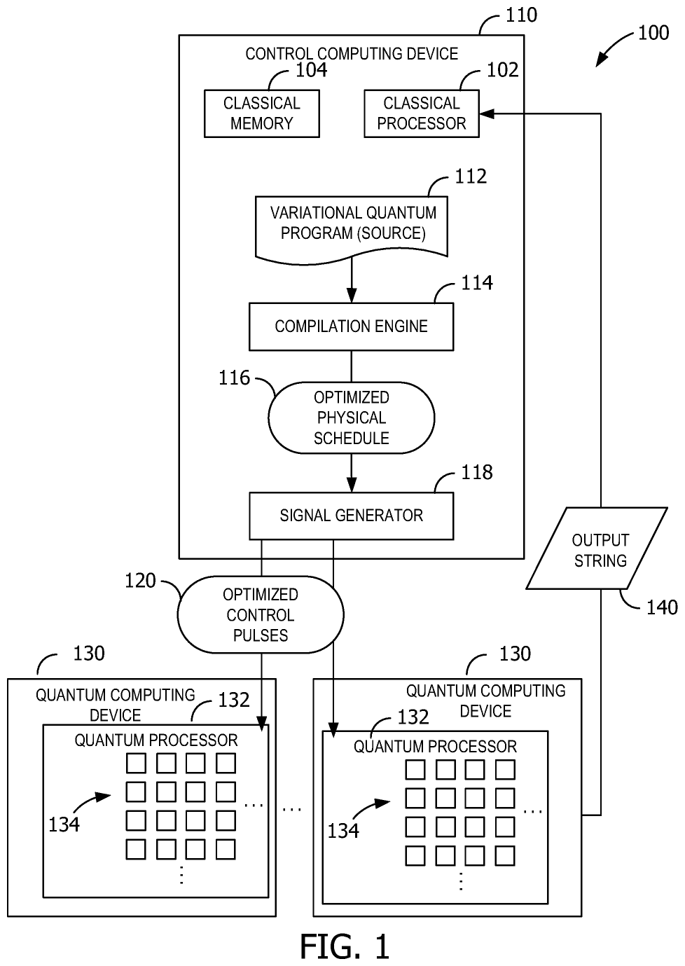

FIG. 1 is a diagram of exemplary ensemble of quantum computing devices 100 for executing a quantum application on a plurality of quantum computing devices 130s. The ensemble of quantum computing devices 100 may include a control computing device 110 that is configured to prepare (e.g., compile and optimize) a quantum program 112 for execution on the quantum computing devices 130s. In particular, different quantum application operations of the quantum application may be executed in parallel using the quantum computing devices 130s. More than one quantum computing device of the plurality of quantum computing devices 130s may perform a particular or a respective quantum application operation of the quantum application operations in parallel.

The control computing device 110 may include a classical processor 102 (e.g., a central processing unit (“CPU”), an x86-based processor, or the like) that can be configured to execute classical processor instructions, a classical memory 104 (e.g., random access memory (“RAM”), memory SIMM, DIMM, or the like, that includes classical bits of memory). A quantum computing device 130 of the quantum computing devices 130s may include multiple qubits 134 that represent a quantum processor 132 upon which the quantum application program 112 is executed.

In some examples, the quantum application program 112 may be a variational quantum application program that interleaves compilation with computation during runtime, and the quantum processor 132 may include 50 or 100 qubits, but it should be understood that the present disclosure is envisioned to be operable and beneficial for quantum processors with any number of qubits, for example, many tens, hundreds, or more qubits 134.

The fundamental unit of quantum computation is a quantum bit (or a qubit) 134. In contrast to classical bits (“cbits”), qubits are capable of existing in a superposition of logical states, notated herein as |0 [symbol] and |1 [symbol] . The general quantum state of a qubit may be represented as:

$$\vert 1 〉 = \vert 0 〉 + \vert 1 〉 ,$$

where, are complex coefficients with | |+| |=1. When measured in the 0/1 basis, the quantum state collapses to |0 [symbol] or |1 [symbol] with a probability of | | and | |, respectively. The qubit 134 can be visualized as a point on a 3D sphere called the Bloch sphere. Qubits 134 can be realized on different Quantum Information Processing (QIP) platforms, including ion traps, quantum dot systems, and, in the example embodiment, superconducting circuits. The number of quantum logical states grows exponentially with the number of qubits 134 in the quantum processor 132. For example, a system with three qubits 134 can live in the superposition of eight logical states: |000 [symbol] , |001 [symbol] , |010 [symbol] , |011 [symbol] , . . . , |111 [symbol] . This property sets the foundation of potential quantum speedup over classical computation. In other words, an exponential number of correlated logical states can be stored and processed simultaneously by the quantum system 100 with a linear number of qubits 134.

A quantum algorithm may be described in terms of a quantum circuit. During quantum compilation, the quantum application program 112 may be first decomposed into a set of 1- and 2-qubit discrete quantum operations called logical quantum gates. These quantum gates are represented in matrix form as unitary matrices. 1-qubit gates correspond to rotations along a particular axis on the Bloch sphere. In an example quantum instruction set architecture (“ISA”), the 1-qubit gate set may include rotations along the x-, y-, and z-axes of the Block sphere. Such gates are notated herein as, and gates, respectively. Further, the quantum ISA may also include a Hadamard gate, which corresponds to a rotation about the diagonal x+z axis. An example of a 2-qubit logical gate in the quantum ISA is a Controlled-NOT (“CNOT” or “CX”) gate, which flips the state of the target qubit if the control qubit is |1 [symbol] or leaves the state unchanged if the control qubit is |0 [symbol] . For example, the CX gate sends |10 [symbol] to |11 [symbol] , sends |11 [symbol] to |10 [symbol] , and preserves the other logical states.

Further, it should be understood that the general logical assembly instructions typically used during compilation of the variational quantum application program 112 were designed without direct consideration for the variations in the types of physical hardware that may be used. As such, there is often a mismatch between the logical instructions and the capabilities of the particular QIP platform. For example, on some QIP platforms, it may not be obvious how to implement the CX gate directly on that particular physical platform. As such, a CX gate may be further decomposed into physical gates in a standard gate-based compilation. Other example physical quantum gates for various architectures include, for example, in platforms with Heisenberg interaction Hamiltonian, such as quantum dots, the directly implementable 2-qubit physical gate is the \sqrt{ } gate, which implements a SWAP when applied twice. In platforms with ZZ interaction Hamiltonian, such as superconducting systems of Josephson flux qubits and NMR quantum systems, the physical gate is the CPhase gate, which is identical to the CX gate up to single qubit rotations. In platforms with XY interaction Hamiltonian, such as capacitively coupled Josephson charge qubits (e.g., transmon qubits), the 2-qubit physical gate is iSWAP gate. For trapped ion platforms with dipole-chain interaction, two popular physical 2-qubit gates are the geometric phase gate and the XX gate.

The quantum processor 132 can be continuously driven by external physical operations to any state in the space spanned by the logical states. The physical operations, called control fields, are specific to the underlying system, with control fields and system characteristics controlling a unique and time-dependent quantity called the Hamiltonian. The Hamiltonian determines the evolution path of the quantum states. For example, in superconducting systems such as the example quantum computing device 130, the qubits 134 can be driven to rotate continuously on the Bloch sphere by applying microwave electrical signals. By varying the intensity of the microwave signal, the speed of rotation of the qubit 134 can be manipulated. The ability to engineer the system Hamiltonian in real time allows the quantum computing system 100 to direct the qubits 134 to the quantum state of interest through precise control of related control fields. Thus, quantum computing may be achieved by constructing a quantum system in which the Hamiltonian evolves in a way that aligns with high probability upon final measurement of the qubits 134. In the context of quantum control, quantum gates can be regarded as a set of pre-programmed control fields performed on the quantum processor 132.

During operation, the control computing device 110 implements a quantum algorithm, attempting to create as efficient a quantum circuit as possible, where efficiency may be in terms of circuit width (e.g., number of qubits) and depth (e.g., length of critical path, or runtime of the circuit). In some embodiments, the compilation engine 114 optimizes various circuits or subcircuits using IBM Qiskit transpiler, which applies a variety of circuit identities (e.g., aggressive cancellation of CX gates and Hadamard gates). In some embodiments, the compilation engine 114 also performs additional merging of rotation gates (e.g., (α) followed by (β) merges into (α+β)) to further reduce circuit sizes.

At the lowest level of hardware, quantum computers are controlled by analog pulses. Therefore, quantum compilation translates from a high-level quantum algorithm down to a sequence of control pulses 120. Once a quantum algorithm has been decomposed into a quantum circuit comprising single- and two-qubit gates, gate-based compilation can be performed by concatenating a sequence of pulses corresponding to each gate. In particular, a lookup table maps from each gate in the gate set to a sequence of control pulses that executes that gate. Pure gate-based compilation provides an advantage in short pulse compilation time, as the lookup and concatenation of pulses can be accomplished very quickly. Some known methods of compilation for variational algorithms use the gate-based approach to compilation, using parameterized gates such as (θ) and (ϕ). However, the pure gate-based compilation approach prevents the optimization of pulses from happening across the gates because there might exist a global pulse for an entire circuit that is shorter and more accurate than the concatenated one. The quality of the concatenated pulse relies heavily on an efficient gate decomposition of the quantum algorithm. GRAPE is a strategy for compilation that numerically finds the best control pulses needed to execute a quantum circuit or sub-circuit by following a gradient descent procedure. In contrast to the gate-based approach, GRAPE does not have the limitation incurred by the gate decomposition. Instead, the GRAPE-based approach directly searches for the optimal control pulse for the input circuit as a whole. Some embodiments described herein utilize GRAPE for portions of compilation, as described in further detail below.

In the example embodiment, the control computing device 110 includes a compilation engine 114 that, during operation, is configured to compile the variational quantum application program 112 (e.g., from source code) into an optimized physical schedule 116. The quantum computing device 130 is a superconducting device and the signal generator 118 is an arbitrary wave generator (“AWG”) configured to perform the optimized control pulses 120 on the quantum processor 132 (e.g., via microwave pulses sent to the qubits 134, where the axis of rotation is determined by the quadrature amplitude modulation of the signal and where the angle of rotation is determined by the pulse length of the signal). The optimized physical schedule 116 represents a set of control instructions and associated schedule that, when sent to the quantum computing device 130 as optimized control pulses 120 (e.g., the pre-programmed control fields) by a signal generator 118, cause the quantum computing device 130 to execute the quantum program 112.

In the example embodiment, the optimized physical schedule 116 may represent a set of control instruction and associated schedule corresponding to each quantum computing device 130 of the ensemble of quantum computing device to perform a respective quantum application operation of the quantum application operations. An expected output string 140 for the ensemble of quantum devices may be measured or identified. It should be understood that other quantum computing architectures may have different supporting hardware.

In some example embodiments, the variational quantum program 112 may be a Variational Quantum Eigensolver (VQE). The quantum computing system 100 may use VQE to find the ground state energy of a molecule. This task is exponentially difficult in general for a classical computer, but efficiently solvable by a quantum computer. Estimating the molecular ground state has important applications to chemistry such as determining reaction rates and molecular geometry. A conventional quantum algorithm for solving this problem is the Quantum Phase Estimation (QPE) algorithm. However, for target precision &, QPE yields a quantum circuit with depth O(1/ε), whereas VQE algorithm yields O(1/ ) iterations of depth O(1) circuits. The latter assumes a more relaxed fidelity requirement on the qubits and gate operations, because the higher the circuit depth, the more likely the circuit experiences an error at the end, and possibly wrong output string may be generated from execution of the quantum application program.

Even if quantum computing devices are manufactured in a highly controlled setting, unavoidable variation may result in each quantum computing device to have different intrinsic properties. Due to each quantum computing device having different intrinsic properties, each quantum computing device's performance is impacted differently even if each quantum computing device is subjected to the same input conditions in a controlled environment. This variation (in intrinsic properties) between and within quantum computing devices becomes apparent while examining error rates.

In some examples, diversity within a quantum computing device across different qubits, and/or diversity between quantum computing devices may cause each quantum computing device to have different coherence time across qubits. For example, coherence time that is indicative of the circuit durations at which amplitude damping occurs, is found to lower for 27 qubits on IBM Quantum Hanoi in comparison with 27 qubits on IBM Quantum Montreal. In other words, there is a higher probability of amplitude damping in IBM Quantum Montreal than in IBM Quantum Hanoi. Also, a 4-qubits quantum application circuit mapped to qubits (e.g., 2, 3, 5, and 6) is observed to decohere faster than when the same circuit is mapped to qubits (e.g., 9, 10, 12, and 13). Accordingly, it may be concluded that execution fidelity may be very different for deeper quantum application circuits (e.g., circuits having longer path). A path of the quantum application circuit is an integer number and represents a number of gates to be executed in a path.

In some examples, in the same quantum computing device, CNOT errors (or errors on 2-qubit CNOT gates) and/or readout errors (or errors on qubit measurements) may be different based on qubits between which a CNOT gate is placed. For example, a CNOT gate between qubits 12 and 15 may have lower fidelity in comparison with the same CNOT gate between qubits 14 and 16. Thus, heterogeneity in qubit connectivity within the quantum computing device and/or across quantum computing devices, choice of a quantum computing device selected (e.g., IBM Quantum Montreal vs. IBM Quantum Hanoi) or qubits/mappings may have a very different post device mapped circuit structures. Similarly, a likelihood of readout error may also be different for different quantum computing devices, and, also within the same quantum computing device depending on a qubit for which a measurement or a readout is performed.

Accordingly, for the same quantum application circuit, on different quantum computing devices, and/or on different qubits/mappings within the same quantum computing device, output probability distributions may be very different. In other words, identifying what is the correct output for the quantum application circuit may be difficult to find out. Further, every time, the quantum computing device is calibrated, intrinsic characteristics of the quantum computing device may change substantially and may also drift between calibrations. IBM Quantum machines are generally calibrated once a day.

Thus, a quantum application's execution fidelity is generally poor, and its impact may not be inferred (e.g., directly, or indirectly) simply based on observation of error rates and/or decoherence times. In the present disclosure, a solution to identify a correct output (or an output string) of a quantum application circuit being executed on noisy quantum devices, and thereby, increasing execution fidelity of the quantum application circuit is described.

The proposed solution includes building a Clifford canary circuit corresponding to a target quantum application circuit. The Clifford canary circuit corresponding to a target quantum application circuit is generated using Clifford gates, which are part of a Clifford group. In particular, the Clifford group includes Hadamard gates, S gates, and CNOT gates. As stated in the Gottesman-Knill theorem, circuits made up on only Clifford gates (or Clifford operations) are classically simulable in polynomial time, which is defined as m(n)=O(n^{k}), where m(n) is an execution time of a computation, and O(n^{k}) is a polynomial function in which k is a constant. However, in some embodiments, and by way of a non-limiting examples, a canary circuit that is simulable on a classical computing device may include a small number of gates (e.g., a Toffoli gate, a unitary matchgate) which are not in the Clifford group.

The Clifford only circuit may be leveraged to construct a canary circuit, which closely resembles a target quantum application's structure. Further, since the Clifford only circuit is classically simulable on a classic computing device, a correct output can be estimated by executing the Clifford only circuit on the classic computing device in an efficient manner. Once the correct output of the Clifford canary circuit, based on its execution on the classic computing device, is identified, an ordering of quantum computing devices of the ensemble, which would more likely produce the known correct output of the Clifford canary circuit (from its execution on the classical computing device) may be determined. Since the Clifford canary circuit closely resembles with the target quantum application circuit, the ordering of quantum computing devices of the ensemble for the Clifford canary circuit has a higher likelihood to be similar to an ordering of quantum computing devices of the ensemble producing the correct output (or output string) for the quantum application circuit. In other words, a particular ordering sequence identified for most of the quantum computing devices of the ensemble for the canary circuit may be the same ordering sequence for the quantum application circuit.

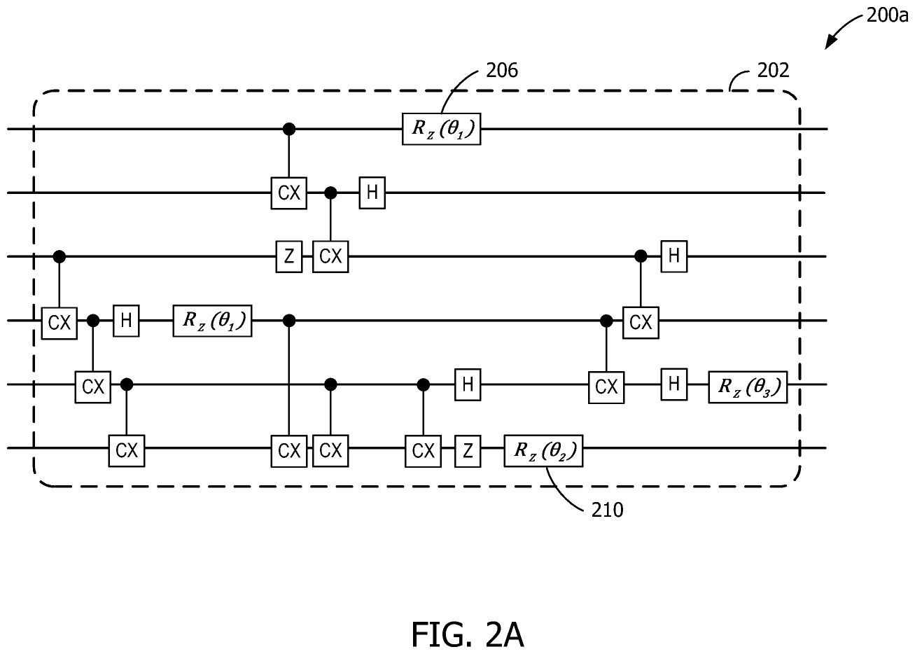

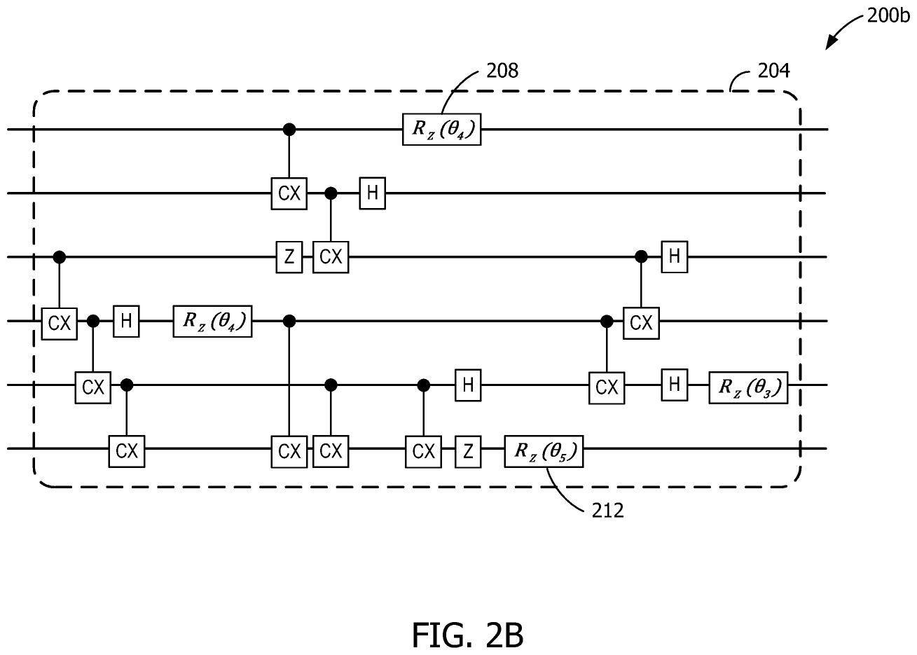

FIG. 2A and FIG. 2B illustrate views corresponding to generating a Clifford canary circuit that closely resembles to a structure of a quantum application circuit. As shown in a view 200a of FIG. 2A, an example quantum application circuit 202 is shown. The quantum application circuit 202 may be mapped to a quantum computing device. In one example, the quantum application circuit 202 may be mapped to a IBM Quantum device on which basis gates include a CNOT gate, an identity (ID) gate, a RX gate performing a single-qubit rotation through angle θ in radians around the X axis, a SX gate performing rotation about the X axis of the Bloch Sphere by 90° or π/2 radians in the counter-clockwise direction, and/or X gates. These basis gates are such that only non-Clifford gates are rotational gates about the Z axis (RZ) with angles that are not multiples of π/2 radians. Further, in a quantum application circuit, any number of such gates may be present.

A view 200b of FIG. 2B illustrates a Clifford canary circuit 204 corresponding to the quantum application circuit 202. The Clifford canary circuit 204 may be generated by rounding the non-Clifford RZ gates to the nearest Clifford gates. In other words, non-Clifford RZ gate in a quantum application circuit 202 may be rounded to nearest multiple of π/2 radians to generate the Clifford canary circuit 204. For example, a non-Clifford RZ (θ₁) gate 206, where θ₁ is −15π/16 radians, may be replaced by a RZ (θ₄) gate 208, where θ₄ may be π radians, which is a Clifford gate. Similarly, a non-Clifford RZ (θ₂) gate 210, where θ₂ may be 3π/16 radians, may be replaced by a RZ (θ₅) gate 212, where θ₅ may be 0 radians, which is also a Clifford gate. In some examples, an RZ gate having a rotation angle of 0 radians may be removed from the Clifford canary circuit 204.

As described herein, since all gates in the Clifford canary circuit 204 are Clifford gates, the Clifford canary circuit 204 may be efficiently simulated on a classic computing device. From simulation of the Clifford canary circuit 204 on the classic computing device, a correct output for the Clifford canary circuit 204 may be known or determined. In addition, in the Clifford canary circuit 204, a structure of a quantum application circuit 202 is maintained, and, therefore, the Clifford canary circuit 204 and the quantum application circuit 202 both are impacted by the same noise sources, even if an exact impact of the same noise source may be different for the Clifford canary circuit 204 and the quantum application circuit 202. However, impact on the execution fidelity may be same for the Clifford canary circuit 204 and the quantum application circuit 202.

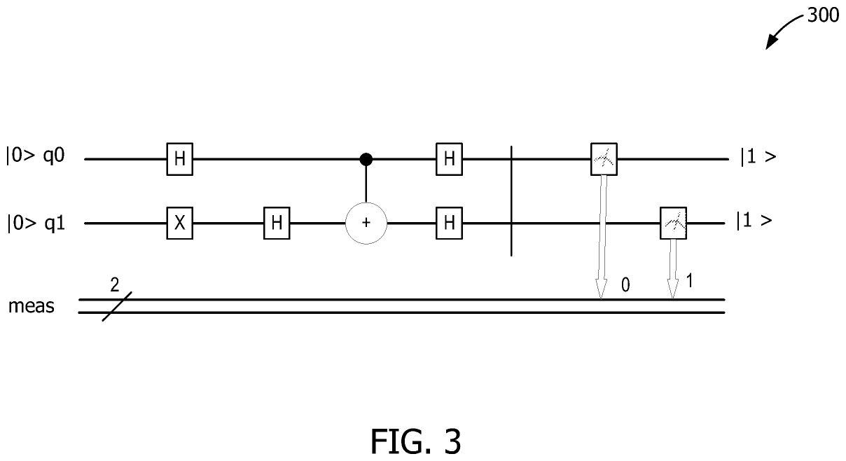

In FIG. 3, an example 2-qubit quantum application circuit 300 is shown. When the quantum application circuit 300 is executed on real quantum computing devices, the quantum application circuit 300 may suffer from decoherence, 1-qubit and/or 2-qubit gate errors, readout errors, and/or crosstalk, and so on. Impact of decoherence, 1-qubit and/or 2-qubit gate errors, readout errors, crosstalk, and so on, may increase with an increase in quantum application circuit's complexity. For the 2-qubit quantum application circuit 300, output bitstrings may be “00,” “01,” “10,” and “11.” Since there is significant noise present in the quantum application circuit, a correct output bitstring may not be the one which is the most probable output bitstring. Accordingly, capturing an output bitstring having the highest probability would not be sufficient.

As shown in FIG. 3, the quantum application circuit 300 may include various 1- and 2-input quantum gates may for a quantum processor 132. The fundamental unit of quantum computation is the qubit (e.g., qubit 134). A qubit has two basis states, which may be represented by state vectors denoted:

$$\begin{matrix}\vert 0 〉 = \begin{matrix}1 \\ 0\end{matrix} & \vert 1 〉 =\end{matrix} \begin{matrix}0 \\ 1\end{matrix} .$$

Unlike a classical bit, the state of a qubit can be in a superposition of both |0 [symbol] and |1 [symbol] . In particular, the space of valid qubit states is |0 [symbol] +|1 [symbol] , normalized such that | |+| |=1. When a qubit is measured, its quantum state collapses and either |0 [symbol] or |1 [symbol] are measured, with probabilities and, respectively.

A 2-qubit system has four basis states:

$$\begin{matrix}\vert 00 〉 = \begin{matrix}1 \\ 0 \\ 0 \\ 0\end{matrix} , & \vert 01 〉 = \begin{matrix}0 \\ 1 \\ 0 \\ 0\end{matrix} ,\end{matrix} \qquad \begin{matrix}\vert 10 〉 = \begin{matrix}0 \\ 0 \\ 1 \\ 0\end{matrix} , & \vert 11 〉 = \begin{matrix}0 \\ 0 \\ 0 \\ 1\end{matrix} ,\end{matrix}$$

and any 2-qubit state can be expressed as the superposition |00 [symbol] +|01 [symbol] +|10 [symbol] +|11 [symbol] , normalized such that | |+| |+| |+| |=1. More generally, an N-qubit system has 2 basis states. Therefore, 2 numbers, called amplitudes, are needed to describe the state of a general N-qubit system. This exponential scaling gives rise to both the difficulty of classically simulating a quantum system, as well as the potential for quantum computers to exponentially outperform classical computers in certain applications.

In FIG. 3, each horizontal line (not separately numbered) may represent a particular qubit 134 of the quantum processor 132. FIG. 3 also identifies several 1- and 2-qubit gates that operate on the qubits. Quantum gates may be represented by a square matrix and the action of a gate is to left-multiply a state vector of the qubit(s) by the gate's matrix. Because quantum states are normalized by measurement probabilities, these matrices preserve-norms. This corresponding set of matrices are unitary (orthogonal) matrices. The unitary matrices for two important 1-qubit gates are:

$$\begin{matrix}( ) = \begin{matrix}{cos}_{\overline{2}} & {sin}_{\overline{2}} \\ {sin}_{\overline{2}} & {cos}_{\overline{2}}\end{matrix} & ( ) =\end{matrix} \begin{matrix}1 & 0 \\ 0 & \end{matrix} .$$

At θ=π, the ( ) gate has a matrix

$$\begin{matrix}1 & 0 \\ 0 & - 1\end{matrix} ,$$

which acts as a NOT gate (e.g., left multiplying by it swaps between the |0 [symbol] and |1 [symbol] states). This bit-flip gate is termed the “X” gate (not shown) herein. Similarly, at ϕ=π, the ( ) gate has a matrix

$$\begin{matrix}0 & 1 \\ 1 & 0\end{matrix} ,$$

which applies a−1 multiplier to the amplitude of |1 [symbol] . This type of gate is unique to the quantum setting, where amplitudes can be negative (e.g., complex). This phase-flip gate is termed the “Z” gate herein.

A “CX” gate is a controlled NOT (or CNOT) represented as:

$$= \begin{matrix}1 & 0 & 0 & 0 \\ 0 & 1 & 0 & 0 \\ 0 & 0 & 0 & 1 \\ 0 & 0 & 1 & 0\end{matrix} .$$

The CX gate applies an action that is controlled on a first input (e.g., the first qubit). If the first input is |0 [symbol] , then the CX gate has no effect. If the first input is |1 [symbol] , then the CX gate applies an X=( ) to the second qubit. The CX gate is an entangling gate, meaning that its effect cannot be decomposed into independent gates acting separately on the two qubits. An important result in quantum computation states that the set of all 1-qubit gates, plus a single entangling gate, is sufficient for universality. Since the ( ) and ( ) gates span the set of all one qubit gates, {( ), ( ), CX} is a universal gate set.

During operation, the quantum computing system 100 prepares the quantum algorithm for execution, maximizing efficiency in the quantum circuit in various respects (e.g., in terms of “circuit width” or number of qubits and “depth” or length of critical path). For example, the quantum circuit may be optimized by repeatedly applying gate identities that reduce the resources consumed by the circuit. In some embodiments, the circuit or various sub-circuits may be optimized using IBM Qiskit transpiler, which applies a variety of circuit identities (e.g., aggressive cancellation of CX gates and Hadamard gates), as well as a customized compiler pass for merging rotation gates (e.g., ( ) followed by ( )), which can further reduce circuit sizes.

In typical gate-based compilations, once a quantum program is decomposed into quantum circuit such as the circuit 300 shown here, gate-based compilation simply involves concatenating together sequences of pulses corresponding to each gate (e.g., via a lookup table mapping each gate into a sequence of control pulses that executes that gate).

In some embodiments, the quantum application circuit 300 may be executed on a diverse ensemble of quantum computing devices, and an ordering quantum computing devices of the ensemble may be used to identify a correct output of a quantum application circuit, e.g., the quantum application circuit 300. The quantum application circuit 300 may be executed on the ordered diverse ensemble of quantum computing devices. By way of a non-limiting example, the ensemble of quantum computing devices may include 20 different quantum computing devices, which are ordered according to an increasing noise, e.g., increasing 1-qubit or 2-qubit decoherence times, crosstalk, and/or readout errors, and so on. As the noise increases, probability of a correct output may decrease in high positive correlation with decreasing quantum computing device's quality, and probability of an incorrect output may increase in high negative correlation as quality of the quantum computing device worsens. Based on this correlation of an output string with the quality of the quantum computing machine's quality, a correct output bitstring may be identified.

In some embodiments, for hard-to-execute quantum application circuits having low fidelity due to high depth of the quantum application circuit, or another reason, a correct output (or output bitstring) for a quantum application circuit may not be identified even by using Quancorde. In such cases, instead of the correct output (or output bitstring), a subset of outputs may be identified. The identified subset of outputs is more likely to include a correct output.

The subset of outputs may be identified by executing a target application (e.g., a Clifford canary circuit corresponding to a target quantum application circuit) on resources of an ensemble. The resources of the ensemble may be within the same quantum computing device or across different quantum computing devices. In some examples, the target application may be executed on diverse ensemble of, for example, 20 or more quantum computing devices. Probability of each output bitstring on each resource of the ensemble may be measured or identified. Correlation of output probabilities for each output bitstrings for an ordered resources of the ensemble may be estimated.

Since knowing an ensemble ordering that is well correlated with the target application's fidelity, a correct application outcome may be identified. However, finding a proper ordered ensemble is not a trivial task for a complex circuit because of more complex interactions among qubits and noise sources. However, as described herein, a canary circuit (e.g., a Clifford canary circuit) may be used to identify an appropriate ordering of ensemble resources.

As described herein, impact of noise on the fidelity of a target application circuit is closely tied to the quantum computing device-mapped structure, for example, a number of 2-qubit CNOT gates and qubits on which the CNOT gates are placed, qubits involved in long and potentially decohering paths, one or more qubits contributing to worse readout errors, etc. Accordingly, a canary circuit that closely mimics the device-mapped structure of the original quantum target application circuit, may be used to understand the diverse impact of noise, for example, from the ensemble, on the original quantum target application circuit, if the correct output (or output bitstring) is known.

In order to find the correct output (or output bitstring), the canary circuit is produced using only Clifford gates by replacing all non-Clifford gates in the target quantum application circuit with the nearest Clifford gates. Since the Clifford canary circuit can be efficiently simulable on a classic computing device, a correct output of the Clifford canary circuit may be known or identified. Upon knowing the correct output of the Clifford canary circuit, resources in the ensemble may be ordered that improves fidelity to generate the correct output of the Clifford canary circuit. The appropriate ordering of resources of the ensemble may be identified by executing the Clifford canary circuit on the noisy ensemble and evaluating probability to generate the correct output of the Clifford canary circuit (based on its execution on the classic computing device). The ordering of resources of the ensemble, with increases probability of generating the correct output, is most likely going to be a correct ordering because of the Clifford canary circuit's similarity with the target quantum application circuit.

The ordering of resources of the ensemble is thus obtained using noise information that is dynamic in nature overcoming disadvantages associated with an ordering of resources of the ensemble that is obtained using static noise information. The static noise information, as referenced herein, may refer to qubit mappings and corresponding coherence/decoherence times and/or gate errors. The static noise information is generally available from the most recent calibration of the quantum computing device. As stated herein, generally, the quantum computing device is calibrated once every day. However, because the static noise information is generally stale because the quantum computing device is characterized only at coarse granularities of time since per-qubit characterization is very time consuming, and the noise characteristics of qubits generally tend to drift over time. Even if, assuming that the static noise information is accurate, it is non-trivial to obtain or identify impact of (static) noise characteristics on the fidelity of a quantum application circuit of reasonable complexity. Determining impact of (static) noise characteristics requires understanding every stage of the quantum application circuit's execution, which is as complex as the quantum application circuit's execution itself, and, therefore, classically inefficient.

The embodiments described herein thus describe identifying an appropriate ordering of resources of an ensemble executing a target quantum application circuit, and, thereby, increasing execution fidelity of the target quantum application circuit. By way of a non-limiting example, the target quantum application circuit may include one or more Ripple Carry Adders. The target quantum application circuit may be a Quantum Fourier Transform (QFT) circuit and/or an Inverse QFT circuit. The target quantum application circuit may be based on a variational quantum-classical algorithm, e.g., a Quantum Approximate Optimization Algorithm (QAOA).

In some examples, a Ripple Carry Adder, which is critical building block of a quantum logic, may have a linear depth, and may be added to a quantum application circuit of 2-6 bits utilizing 6-14 qubits, respectively. The QFT circuit may be a building block for quantum applications, such as Shor's factoring and phase estimation. The QFT circuit converts a quantum state from a computational basis to the Fourier basis through introduction of phase. The QFT circuit may be concatenated with an Inverse QFT circuit. The QFT circuit may be constructed for 6-10 qubits. The QAOA may be implemented atop a parametrized circuit, e.g., an ansatz. The QAOA ansatz may be constructed for 6 qubits for 4 different input graphs.

In some examples, the Quancorde, as described herein, may be implemented using any software development kit (SDK) or a transpiler working with quantum computing devices at the level of pulses, circuits, and/or modules. Each quantum computing device of quantum computing devices of an ensemble may be of any number of qubits, e.g., 16 qubits, 27 qubits, 65 qubits, and so on. In an ensemble, different number of quantum computing devices, e.g., 7 different quantum computing devices, may be used. Each quantum computing device of the quantum computing devices of an ensemble may execute one circuit/operation that is mapped and routed to the quantum computing device by the transpiler. The transpiler may be executing with a particular threshold level of optimization enabled.

In some embodiments, as described herein, greater diversity and/or a larger ensemble size may increase potential for correct output identification, as evident from various Quancorde evaluation metrics. The various Quancorde evaluation metrics include a metric corresponding a rank of correct outcome, a metric corresponding to a relative correlation of correct outcome with respect to highest probability, and/or a metric related to fidelity.

The metric corresponding to a rank of correct outcome may indicate ranking of the correct outcome among correlation of all possible outcomes according to a Clifford canary circuit produced ordering of quantum computing devices of an ensemble. In the most ideal situation, a rank of the correct outcome may be 1 for a simple quantum application circuit. But for a more complex quantum application circuit, a rank of the correct outcome may not be 1, and sensitivity analysis may be required to analyze the worst rank among all possible outcomes. A correct outcome may be found among the worst-ranked number of selected output strings.

The metric corresponding to a relative correlation of correct outcome with respect to highest probability may be referenced herein as a relative correlation (RC) metric and may focus on the correlation of outcome probability according to a Clifford canary circuit produced ordering of quantum computing devices of an ensemble. This metric indicates a relative correlation value of a correct outcome compared to a correlation value of the most correlated outcome. In the most ideal situation, a value of the relative correlation may be 100% for a simple quantum application circuit. But for a more complex quantum application circuit, the correlation value for the correct outcome may not be 100%, and sensitivity analysis may be performed to analyze the worst among all possible outcomes for this metric. Based on the performed sensitivity analysis, it may be determined how far out, from the highest outcome, a search for the correlation distribution to be performed. A correct outcome may be found among the searched output strings. In some examples, a respective weight may be assigned to each outcome of the possible outcomes, and the correlation value may be generated based on the respective weight assigned to each possible outcome.

The metric related to fidelity may be a standard evaluation metric indicating a likelihood of finding the correct outcome of a quantum application circuit. A Quancorde executed on a classic computing device (or a quantum computing device, or an ensemble of quantum computing devices) may generate multiple output strings, for example, K number of output strings, per quantum application circuit. The correct output string may be one of the K numbers of output strings. Then the fidelity of the quantum application circuit may be determined as 1/K since the probability of having the correct output from the set is 1 among K. Across all mappings and/or machines, one having a highest fidelity may be used for the mappings and/or machines.

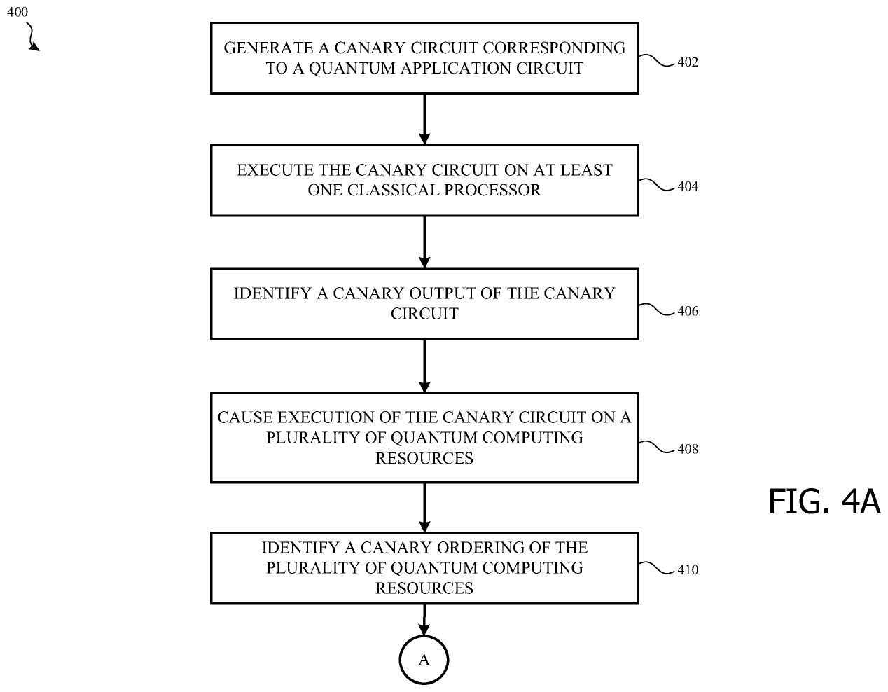

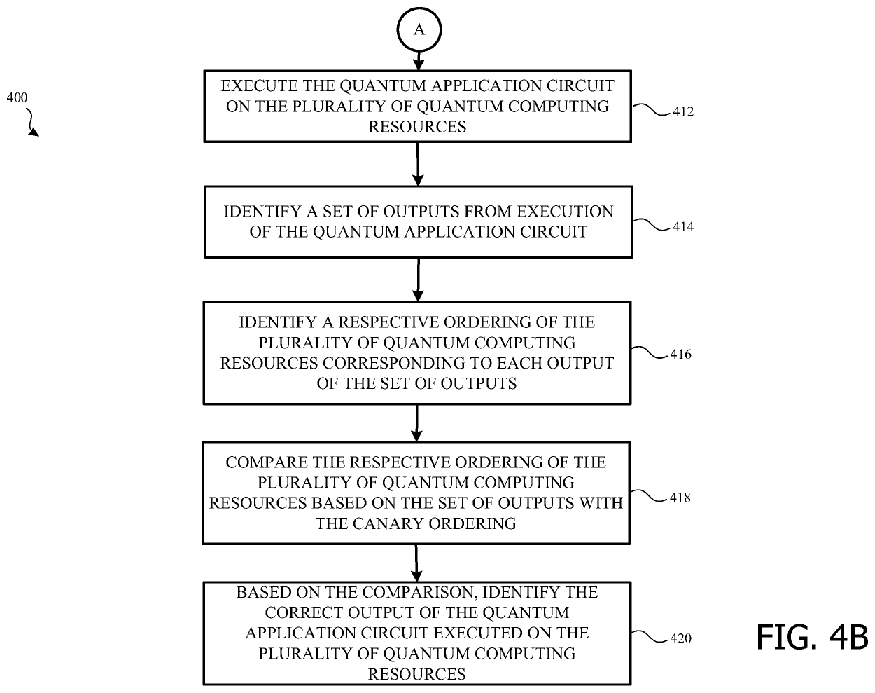

FIG. 4A and FIG. 4B illustrate an example flow-chart of method operations to identify a correct output from execution of a quantum application circuit on quantum computing devices of an ensemble. Method operations specified in a flow-chart 400 may be implemented using at least one classical processor that is in communication with a classical memory storing instructions, which cause the at least one classical processor to perform various method operations. At 402, a canary circuit corresponding a quantum application circuit may be generated. As described herein, the canary circuit may be generated by identified and replacing non-Clifford gates with Clifford gates. For example, an RZ gate having a respective rotation angle in radians that is not multiple of π/2 may be referenced as a non-Clifford gate. One or more non-Clifford gates identified in the quantum application circuit may be replaced with a Clifford gate, which is an RZ gate having a respective rotation angle that is rounded to a nearest multiple of π/2. While generating the canary circuit, if a respective rotation angle of the RZ gate is 0 radians, then such Clifford gate may be removed from, or not included in, the canary circuit.

At 404, the generated canary circuit is executed on the at least one classical processor (or at least one classical computing device) since the canary circuit is efficiently simulable on a classical computing device. The at least classical computing device may be a physical hardware and/or an instance of virtual machine. The at least one classical computing device may be a local classical computing device or may be a classical computing device hosted in a cloud network.

At 406, a canary output, which may be also referenced herein as a classical canary output, is an output based on execution of the canary circuit on the at least classical computing device may be identified or determined. The canary circuit very closely resembles the quantum application circuit, and, therefore, noise sources may have similar impact on both of the canary circuit and the quantum application circuit. Accordingly, an output of canary circuit may be most likely similar to an output of the quantum application circuit as well. As described herein, for a complex quantum application circuit, a canary output may not be the correct output, but a set of outputs generated by the canary circuit may include a correct output among the generated set of outputs.

At 408, the canary circuit may be executed on the plurality of quantum computing resources to generate the canary output (or the classical canary output) generated at 406. More than one quantum computing resource of the plurality of quantum computing resources may be within the same quantum computing device, or across more than one quantum computing devices. As described herein, today's quantum computing devices are noisy, and when the canary circuit is executed on each quantum computing device of the plurality of quantum computing devices, noise sources may impact the canary output in the similar way as the noise sources may impact the quantum application circuit executing on the quantum computing resources. By way of a non-limiting example, operation described herein corresponding to 404 and 408 may be executed simultaneously, or at different times.

At 410, a respective canary ordering of each quantum computing resource of the plurality of quantum computing resources of the ensemble may be identified. In particular, an ordering of each quantum computing resource of the plurality of quantum computing resources that increases a probability (or a likelihood) of generating the classical canary output may be identified at 410.

At 412, the quantum application circuit is executed on each quantum computing resource of the plurality of quantum computing resources. Since each quantum computing resource is noisy, an output from each quantum computing resource may be affected by the noise resources. Each operation of the quantum application circuit may be executed on a respective quantum computing resource of the quantum computing resources; an ordering of quantum computing resources may impact an output of the quantum application circuit executed on the plurality of quantum computing resources of the ensemble. The quantum application circuit is executed on many different orderings of the plurality of quantum computing resources.

Each unique ordering of the plurality of quantum computing resource may produce a unique output. Accordingly, corresponding to each unique ordering of the plurality of quantum computing resources, a set of actual outputs generated by execution of the quantum application circuit on each quantum computing resource of the plurality of quantum computing resources of the ensemble may be identified, as shown in FIG. 4 as 414.

At 416, a respective ordering of each quantum computing resource of the plurality of quantum computing resource that increases probability for generating each actual output of the set of actual outputs may be associated with a respective actual output of the set of actual outputs. At 418, a respective ordering of each quantum computing resource of the plurality of quantum computing resources corresponding to each actual output of the set of actual outputs may be compared with the respective canary ordering of each quantum computing resource of the plurality of quantum computing resources of the ensemble. At 420, based on the comparison performed at 418, an output generated by an ordering of the plurality of quantum application resources that is most closely resembles with the respective canary ordering of each quantum computing resource of the plurality of quantum computing resources of the ensemble may be identified or recognized as the correct output of the quantum application circuit.

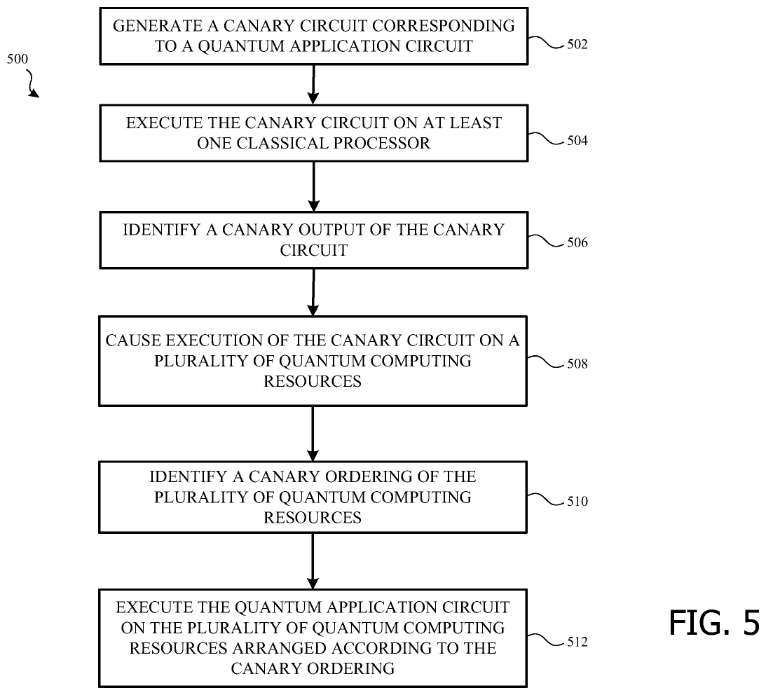

FIG. 5 illustrates an example flow-chart of method operations to identify an appropriate ordering of quantum computing devices of an ensemble that increases execution fidelity of the quantum application circuit. Method operations specified in a flow-chart 500 may be implemented using at least one classical processor that is in communication with a classical memory storing instructions, which cause the at least one classical processor to perform various method operations. At 502, a canary circuit corresponding a quantum application circuit may be generated. As described herein, the canary circuit may be generated by identified and replacing non-Clifford gates with Clifford gates. For example, an RZ gate having a respective rotation angle in radians that is not multiple of π/2 may be referenced as a non-Clifford gate. One or more non-Clifford gates identified in the quantum application circuit may be replaced with a Clifford gate, which is an RZ gate having a respective rotation angle that is rounded to a nearest multiple of π/2. While generating the canary circuit, if a respective rotation angle of the RZ gate is 0 radians, then such Clifford gate may be removed from, or not included in, the canary circuit.

At 504, the generated canary circuit is executed on the at least one classical processor (or at least one classical computing device) since the canary circuit is efficiently simulable on a classical computing device. The at least classical computing device may be a physical hardware and/or an instance of virtual machine. The at least one classical computing device may be a local classical computing device or may be a classical computing device hosted in a cloud network.

At 506, a canary output that is an output based on execution of the canary circuit on the at least classical computing device may be identified or determined. The canary output may also be referenced herein as classical canary output. The canary circuit very closely resembles the quantum application circuit, and, therefore, noise sources may have similar impact on both of the canary circuit and the quantum application circuit. Accordingly, an output of canary circuit may be most likely similar to an output of the quantum application circuit as well. As described herein, for a complex quantum application circuit, a canary output may not be the correct output, but a set of outputs generated by the canary circuit may include a correct output among the generated set of outputs.

At 508, the generated canary circuit at 502 is caused to execute on each quantum computing resource of a plurality of quantum computing resources of an ensemble. More than one quantum computing resources may be within the same quantum computing device, or across more than one quantum computing devices. As described herein, today's quantum computing devices are noisy, and when the canary circuit is executed on each quantum computing device of the plurality of quantum computing devices, noise sources may impact the canary output in the similar way as the noise sources may impact the quantum application circuit executing on the quantum computing resources. By way of a non-limiting example, operation described herein corresponding to 504 and 508 may be executed simultaneously, or at different times.

At 510, a respective canary ordering of each quantum computing resource of the plurality of quantum computing resources of the ensemble may be identified. In particular, an ordering of each quantum computing resource of the plurality of quantum computing resources that increases probability of generating the identified canary output may be identified at 510.

At 512, the quantum application circuit is executed on each quantum computing resource of the plurality of quantum computing resources. Each quantum computing resource of the plurality of quantum computing resources of the ensemble is ordered according to the respective canary ordering of each quantum computing resource of the plurality of quantum computing resources of the ensemble. Since each quantum computing resource is noisy, an output from each quantum computing resource may be affected by the noise resources. Each operation of the quantum application circuit may be executed on a respective quantum computing resource of the quantum computing resources; an ordering of quantum computing resources may impact an output of the quantum application circuit executed on the plurality of quantum computing resources of the ensemble. Since the canary circuit resembles the quantum application circuit, and the canary circuit and the quantum application circuit are affected by the noise sources similarly, quantum computing resources arranged according to the respective canary ordering may be the correct ordering of the ensemble, In other words, quantum computing resources arranged according to the respective canary ordering may increase execution fidelity of the quantum application circuit.

Alternatively, at 512, the quantum application circuit is executed on a quantum computing resource of the plurality of quantum computing resources. The quantum computing resource of the plurality of quantum computing resources on which the quantum application circuit is executed may have the highest likelihood of generating the classical canary output when the canary circuit is executed on each quantum computing resource of the plurality of quantum computing resources. Since the canary circuit executed on the plurality of computing resources most resembles with the quantum application circuit, and, therefore, may have an adverse impact from noise sources in a similar fashion, a quantum computing resource that has the highest likelihood of generating the classical canary output may most likely be the best quantum computing resource to execute the quantum application circuit. Accordingly, the quantum computing resource of the plurality of quantum computing resources having a higher likelihood of generating the classical canary output and based on an availability of each quantum computing resource of the plurality of quantum computing resources may be selected to execute the quantum application circuit. By way of a non-limiting example, the availability of each quantum computing resource of the plurality of quantum computing resources may depend on a number of jobs queued for execution by each quantum computing resource of the plurality of quantum computing resources.

Even though, various embodiments are described herein with respect to a quantum application circuit and identifying one or more quantum computing resources of a plurality of quantum computing resources and/or a respective ordering of each quantum computing resource when more than one quantum computing resources are used, the embodiments may be applied in non-quantum computing field, as well. In particular, different classical computing devices may perform differently while executing an application. In some examples, an ordering of classical computing devices may affect performance of the application execution. Accordingly, in accordance with the embodiments described herein, a particular ordering of the classical computing devices may be identified which may increase performance of the application execution.

As will be appreciated based on the foregoing specification, the above-described embodiments of the disclosure may be implemented using computer programming or engineering techniques including computer software, firmware, hardware or any combination or subset thereof, wherein the technical effect is to compile and optimize a variational quantum program for execution on a quantum processor. Any such resulting program, having computer-readable code means, may be embodied, or provided within one or more computer-readable media, thereby making a computer program product, (i.e., an article of manufacture), according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code may be made and/or used by executing the code directly from one medium, by copying the code from one medium to another medium, or by transmitting the code over a network.

These conventional computer programs (also known as programs, software, software applications, “apps,” or code) include machine instructions for a conventional programmable processor and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A quantum computing system providing quantum processing as a service, the quantum computing system comprising:
a plurality of quantum computing resources, each quantum computing resource of the plurality of quantum computing resources including a plurality of qubits;
a classical memory storing an original quantum circuit of a quantum application; and
at least one classical processor executing instructions that cause the at least one classical processor to:
create a canary circuit corresponding to the original quantum circuit;
execute the canary circuit on the at least one classical processor;
identify a classical canary output based on execution of the canary circuit on the at least one classical processor;
execute the canary circuit on the plurality of quantum computing resources to generate the classical canary output;
identify a respective canary ordering of each quantum computing resource of the plurality of quantum computing resources that increases a likelihood of generating the classical canary output when the canary circuit is executed on the plurality of quantum computing resources;
execute the original quantum circuit on each quantum computing resource of the plurality of quantum computing resources;
identify a set of actual outputs generated by execution of the original quantum circuit on the plurality of quantum computing resources;
associate a respective ordering of each quantum computing resource of the plurality of quantum computing resources corresponding to each actual output of the set of actual outputs;
compare the respective ordering of each quantum computing resource of the plurality of quantum computing resources with the respective canary ordering of each quantum computing resource of the plurality of quantum computing resources; and
based on the comparison, determine a correct output of the original quantum circuit, the correct output corresponds with the actual output produced by the respective ordering of each quantum computing resource of the plurality of quantum computing resources that most resembles with the respective canary ordering of each quantum computing resource of the plurality of quantum computing resources.

2. The quantum computing system of claim 1, wherein the plurality of quantum computing resources includes quantum computing resources within a single quantum computing device.

3. The quantum computing system of claim 1, wherein the plurality of quantum computing resources includes quantum computing resources of more than one quantum computing devices.

4. The quantum computing system of claim 1, wherein to create the canary circuit corresponding to the original quantum circuit, the at least one classical processor is further configured to:
identify and replace a non-Clifford gate in the original quantum circuit with a corresponding Clifford gate.

5. The quantum computing system of claim 4, wherein:
the non-Clifford gate is a rotational gate about a Z axis having a respective rotation angle in radians that is not multiple of π/2; and
the corresponding Clifford gate is a rotation gate about the Z axis having a respective rotation angle that is nearest multiple of π/2.

6. The quantum computing system of claim 4, wherein the at least one classical processor is further configured to:
remove the corresponding Clifford gate having the respective rotation angle in the nearest multiple of π/2 is zero radian.

7. The quantum computing system of claim 1, wherein the canary circuit is executed simultaneously on the at least one classical processor and each quantum computing resource of the plurality of quantum computing resources.

8. A method for identifying a correct output of a quantum application circuit executed on a plurality of quantum computing resources, the method is implemented using at least one classical processor in communication with a classical memory, the method comprising:
generating a canary circuit corresponding to the quantum application circuit;
executing the canary circuit on the at least one classical processor;
identifying a classical canary output based on execution of the canary circuit on the at least one classical processor;
causing execution of the canary circuit on the plurality of quantum computing resources to generate the classical canary output;
identifying a respective canary ordering of each quantum computing resource of the plurality of quantum computing resources that increases a likelihood of generating the classical canary output when the canary circuit is executed on the plurality of quantum computing resources;
executing the quantum application circuit on the plurality of quantum computing resources;
identifying a set of actual outputs generated by execution of the quantum application circuit on the plurality of quantum computing resources;
associating a respective ordering of each quantum computing resource of the plurality of quantum computing resources corresponding to each actual output of the set of actual outputs;
comparing the identified respective ordering of each quantum computing resource of the plurality of quantum computing resources with the respective canary ordering of each quantum computing resource of the plurality of quantum computing resources; and
based on the comparison, determining the correct output of the quantum application circuit, the correct output corresponds with the actual output produced by the respective ordering of each quantum computing resource of the plurality of quantum computing resources that most resembles with the respective canary ordering of each quantum computing resource of the plurality of quantum computing resources.

9. The method of claim 8, wherein the plurality of quantum computing resources includes quantum computing resources within a single quantum computing device, and each quantum computing resource has a unique noise characteristic.

10. The method of claim 8, wherein the plurality of quantum computing resources includes quantum computing resources of more than one quantum computing devices, and each quantum computing resource or each quantum computing device of the more than one quantum computing devices has a unique noise characteristic.

11. The method of claim 8, wherein creating the canary circuit corresponding to the quantum application circuit comprises:
identifying a non-Clifford gate in the quantum application circuit; and
replacing the identified non-Clifford gate with a corresponding Clifford gate.

12. The method of claim 11, wherein:
the non-Clifford gate is a RZ gate having a respective rotation angle in radians that is not multiple of π/2; and
the corresponding Clifford gate is a RZ gate having a respective rotation angle that is nearest multiple of π/2.

13. The method of claim 11, further comprising:
removing the corresponding Clifford gate having the respective rotation angle of zero radian.

14. The method of claim 8, further comprising simultaneously executing the canary circuit on the at least one classical processor and each quantum computing resource of the plurality of quantum computing resources.

15. A method for executing a quantum application circuit on a plurality of quantum computing resources, the method is implemented using at least one classical processor in communication with a classical memory, the method comprising:
generating a canary circuit corresponding to the quantum application circuit;
executing the canary circuit on the at least one classical processor;
identifying a classical canary output based on execution of the canary circuit on the at least one classical processor;
causing execution of the canary circuit on the plurality of quantum computing resources to generate the classical canary output;
identifying a respective canary ordering of each quantum computing resource of the plurality of quantum computing resources that increases a likelihood of generating the classical canary output when the canary circuit is executed on the plurality of quantum computing resources; and
executing the quantum application circuit on each quantum computing resource of the plurality of quantum computing resources, each quantum computing resource of the plurality of quantum computing resources is ordered according to the identified respective canary ordering of each quantum computing resource of the plurality of quantum computing resources.

16. The method of claim 15, wherein the plurality of quantum computing resources includes quantum computing resources within a single quantum computing device, or across more than one quantum computing devices.

17. The method of claim 15, wherein creating the canary circuit further comprises:
identifying and replacing a non-Clifford gate in the original quantum circuit with a corresponding Clifford gate.

18. The method of claim 17, wherein:
the non-Clifford gate is a rotational gate about a Z axis having a respective rotation angle in radians that is not multiple of π/2; and
the corresponding Clifford gate is a rotation gate about the Z axis having a respective rotation angle that is nearest multiple of π/2.

19. The method of claim 17, further comprising removing the corresponding Clifford gate having the respective rotation angle in the nearest multiple of π/2 that is zero radian.

20. The method of claim 15, further comprising:
simultaneously executing the canary circuit on the at least one classical processor and each quantum computing resource of the plurality of quantum computing resources; or
executing the canary circuit on the at least one classical processor at a different time than executing the canary circuit on each quantum computing resource of the plurality of quantum computing resources.

21. A method for executing a quantum application circuit on a plurality of quantum computing resources, the method is implemented using at least one classical processor in communication with a classical memory, the method comprising:
generating a canary circuit corresponding to the quantum application circuit;
executing the canary circuit on the at least one classical processor;
identifying a classical canary output based on execution of the canary circuit on the at least one classical processor;
causing execution of the canary circuit on each of the plurality of quantum computing resources to generate the classical canary output;
identifying a respective likelihood of generating the classical canary output on each quantum computing resource of the plurality of quantum computing resources when the canary circuit is executed on each quantum computing resource of the plurality of quantum computing resources; and
based on an availability and the identified likelihood corresponding to each quantum computing resource of the plurality of quantum computing resources, executing the quantum application circuit on a quantum computing resource of the plurality of quantum computing resources.
